(19) United States
(12) Patent Application Publication
(10) Pub. No.: US 2008/0274308 A1
(43) Pub. Date: Nov. 6, 2008

(54) STICKER HAVING HIDDEN IMAGE MADE VISIBLE BY WATER

(76) Inventor: Edison Lu, Jhonghe City (TW)

Correspondence Address: LEONG C LEI, PMB # 1008, 1867 YGNACIO VALLEY ROAD, WALNUT CREEK, CA, 94598, US

(21) Appl. No.: 12/168,920

(22) Filed: Jul. 8, 2008

(30) Foreign Application Priority Data
Apr. 23, 2007 (TW) 097206903

(51) Int. Cl. B44F 1/10

(52) U.S. Cl. 428/29

(57) ABSTRACT

The sticker contains a flat base member made of a water-permeable material, a water-resistant ink layer on a top surface of the base member, a water-soluble dye layer on a bottom surface of the base member, and an adhesive layer on a bottom surface of the dye layer for attaching the sticker to a lottery ticket. The ink layer has a graphical or text image of the same color as the base member so that the image wouldn't be visible. The dye layer has a different color from that of the base member and the ink layer. The dye layer is water-soluble so that, once it is contacted with water, it is dissolved into the water and permeates into the base member. Due to the color difference, the image of the ink layer then becomes visible.

### TECHNICAL FIELD OF THE INVENTION

The present invention generally relates to cryptography, and more particularly to a sticker having a hidden image that is made visible by contacting with water.

### DESCRIPTION OF THE PRIOR ART

A common type of lottery tickets is that some numbers or patterns are printed on the lottery tickets and then the numbers or patterns are concealed by a layer of paint. The buyer of a lottery ticket uses the fingernail or a coin to scratch off the paint and see if he or she has won the lottery.

Since the numbers or patterns are printed on the lottery tickets before hand, the cost of making these lottery tickets is high and how to prevent the maker of the lottery tickets (e.g., stealing those winning tickets) to cheat is also an issue.

### SUMMARY OF THE INVENTION

The primary purpose of the present invention is to provide a lottery ticket. The sticker has a hidden image that is made visible by contacting with water. The production of the lottery tickets and the stickers could therefore be separated to prevent cheating, and a buyer of a lottery ticket could easily find out if this is a winning ticket.

The sticker contains a flat base member made of a water-permeable material, a water-resistant ink layer on a top surface of the base member; a water-soluble dye layer on a bottom surface of the base member, and an adhesive layer on a bottom surface of the dye layer for attaching the sticker to the lottery ticket. The ink layer has a graphical or text image of the same color as the base member so that the image wouldn't be visible. The dye layer has a different color from that of the base member and the ink layer. The dye layer is water-soluble so that, once it is contacted with water, it is dissolved into the water and permeates into the base member. Due to the color difference, the image of the ink layer then becomes visible.

### BRIEF DESCRIPTION OF THE DRAWINGS

FIG. 1 is a sectional diagram showing a sticker according a first embodiment of the present invention.

FIG. 2A is a front-view diagram showing the sticker of FIG. 1.

FIG. 2B is a front-view diagram showing the sticker of FIG. 1 when the hidden image of the sticker is made visible.

FIG. 3 is a perspective diagram showing a sticker according to a second embodiment of the present invention.

### DETAILED DESCRIPTION OF THE PREFERRED EMBODIMENTS

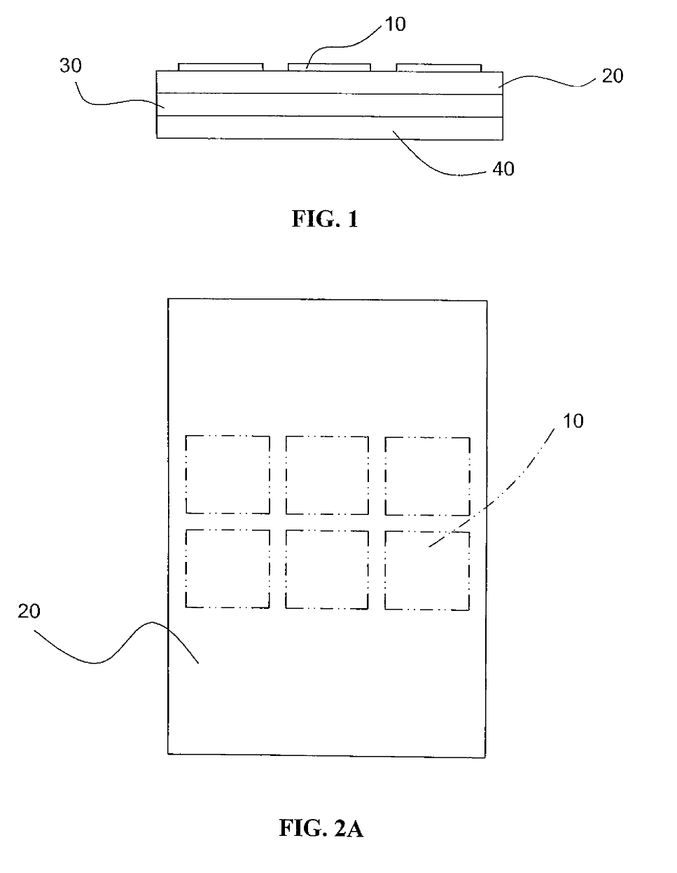

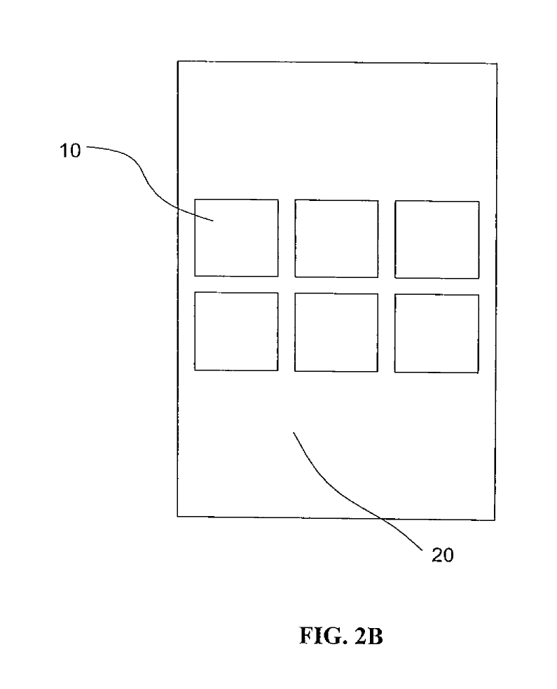

As shown in FIGS. 1, 2A, and 2B, a sticker according to a first embodiment of the present invention contains a flat base member 20, an ink layer 10 on a top surface of the base member 20, a water-soluble dye layer 30 on a bottom surface of the base member 20, and an adhesive layer 40 on a bottom surface of the dye layer 30.

The base member 20 is made of a water-permeable material. Some typical examples of the base member 20 are a piece of cotton paper and a piece of composite cloth.

The ink layer 10 is formed by printing on the top surface of the base member 20 to show a graphical or text image. The ink used by the ink layer 10 has the same color as the base member 20 so that the image wouldn't be visible. In addition, the ink is water-resistant so that the image would not be affected if water is spilled on the sticker.

The dye layer 30 is formed by printing on the bottom surface of the base member 20. The dye used has a different color from that of the base member 20 and the ink layer 10. The dye layer 30 is water-soluble so that, once it is contacted with water, it is dissolved into the water and permeates into the base member 20. Due to the color difference, the image of the ink layer 10 then becomes visible.

The sticker is adhered to a lottery ticket by its adhesive layer 40 with the ink layer 10 facing outward. As mentioned earlier, since the ink layer 10 and the base member 20 are of the same color and therefore the image of the ink layer 10 is not visible. Once the sticker is contacted with water, the dye layer 30 is dissolved and dyes the base member 20 into a different color. As the ink layer 10 is water-resistant and maintains its original color, the image of the ink layer 10, under the contrast of the base member 20, then becomes visible. By comparing the information contained in the lottery ticket with the made-visible image of the sticker, the buyer of the lottery ticket could determine if he or she has won the lottery.

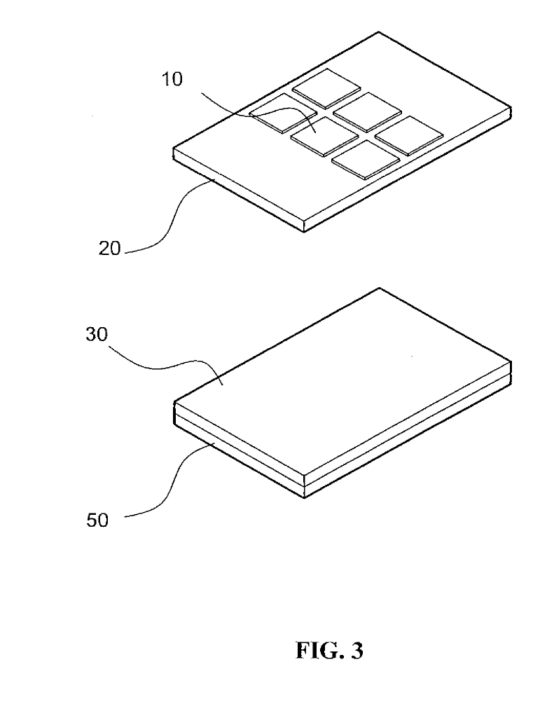

FIG. 3 shows a second embodiment of the present invention which is different from the previous embodiment only in that a double-sided adhesive 50 is used as the adhesive layer 40 so that the sticker could be conveniently attached to any place.

I claim:

1. A sticker, comprising:
a flat base member made of a water-permeable material of a first color;
a water-resistant ink layer having an image of said first color on a top surface of said base member;
a water-soluble dye layer of a second color on a bottom surface of said base member; and
an adhesive layer on a bottom surface of said dye layer;
wherein said first and second colors are different; and, when said sticker is contacted with water and said dye layer is dissolved and permeates into said base member, said base member is dyed by said second color so as to make said image of said first color visible.

2. The sticker according to claim 1, wherein said adhesive layer is a double-sided adhesive.

3. The sticker according to claim 1, wherein said base member is a piece of cotton paper.

4. The sticker according to claim 1, wherein said base member is a piece of composite cloth.
